(19) United States
(12) Patent Application Publication
(10) Pub. No.: US 2026/0173035 A1
(43) Pub. Date: Jun. 18, 2026

(54) MULTICAST AND BROADCAST SERVICES (MBS) MULTICAST ACTIVATION AND DEACTIVIATION NOTIFICATIONS

(71) Applicant: Apple Inc., Cupertino, CA (US)

(72) Inventors: Fangli Xu, Beijing (CN); Peng Cheng, Beijing (CN); Haijing Hu, Los Gatos, CA (US)

(21) Appl. No.: 19/125,174

(22) PCT Filed: Nov. 4, 2022
(86) PCT No.: PCT/CN2022/129802

§ 371 Date: Apr. 28, 2025

(51) Int. Cl. H04W 68/02; H04W 76/20; H04W 76/40

(52) U.S. Cl. CPC H04W 68/02; H04W 76/20; H04W 76/40

(57) ABSTRACT

Disclosed are methods, systems, and computer-readable medium to perform operations including: receiving, from a base station of a wireless network, a group paging message including (i) first data indicating an activation state of a multicast session of the wireless network, and (ii) second data indicating an identifier of the multicast session; determining that a current a Radio Resource Control (RRC) state of the UE device is an inactive RRC state; selecting, based on the group paging message and the current RRC state of the UE device, a RRC state of the UE device for receiving data from the multicast session; and receiving data from the multicast session according to the selected RRC state.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

This disclosure sets forth various techniques for facilitating Multicast and Broadcast Services (MBS) on a wireless network, such as a cellular network.

In an example implementation, a base station (BS) of a wireless network can transmit data to multiple user equipment (UE) devices concurrently via a multicast session (e.g., a communications session in which at least some of the same data is transmitted to each of the UE devices concurrently). Further, based on information obtained from the BS, each of the UE devices can determine whether to receive data from the multicast session according to a particular Radio Resource Control (RRC) state, such as an inactive RRC state or a connected RRC state. Further, based on information obtained from the BS, each of the UE devices can determine whether to selectively discontinue receiving data from the multicast session.

In accordance with one aspect of the present disclosure, a UE device includes one or processors and one or more storage devices on which are stored instructions that are operable, when executed by the one or more processors, to cause the one or more processors to perform operations including: receiving, from a base station of a wireless network, a group paging message including: first data indicating an activation state of a multicast session of the wireless network, and second data indicating an identifier of the multicast session; determining that a current a Radio Resource Control (RRC) state of the UE device is an inactive RRC state; selecting, based on the group paging message and the current RRC state of the UE device, a RRC state of the UE device for receiving data from the multicast session; and receiving data from the multicast session according to the selected RRC state.

Implementations of this aspect can include one or more of the following features.

In some implementations, the group paging message can further include third data indicating a preferred RRC state for the UE device selected by the wireless network. Selecting the RRC state of the UE device for receiving data from the multicast session can include: determining that the activation state of the multicast session is an activated state, determining that preferred RRC state is an inactive RRC state, and selecting the inactive RRC state for receiving data from the multicast session.

In some implementations, the group paging message can further include third data indicating a preferred RRC state for the UE device selected by the wireless network. Selecting the RRC state of the UE device for receiving data from the multicast session can include: determining that the activation state of the multicast session is an activated state, determining that preferred RRC state is a connected RRC state, and selecting the connected RRC state for receiving data from the multicast session.

In some implementations, selecting the RRC state of the UE device for receiving data from the multicast session can include: determining that the activation state of the multicast session is an activated state, determining an absence of data indicating a preferred RRC state for the UE device in the group paging message, and determining that at least one of (i) the UE device has received Point-to-Multipoint (PTM) configuration information for the multicast session from the wireless network or (ii) the wireless network has indicated to the UE device that the PTM configuration information will be provided to the UE device, and selecting the inactive RRC state for receiving data from the multicast session.

In some implementations, selecting the RRC state of the UE device for receiving data from the multicast session can include: determining that the activation state of the multicast session is an activated state, determining an absence of data indicating a preferred RRC state for the UE device in the group paging message, determining that (i) the UE device has not received Point-to-Multipoint (PTM) configuration information for the multicast session from the wireless network and (ii) the wireless network has not indicated to the UE that the PTM configuration information will be provided to the UE device, and selecting a connected RRC state for receiving data from the multicast session.

In some implementations, the operations can further include: receiving, from the base station of the wireless network, a second group paging message indicating that the activation state of the multicast session of the wireless network is a deactivated state, and terminating a receipt of data from the multicast session.

In accordance with another aspect of the present disclosure, a UE device includes one or processors and one or more storage devices on which are stored instructions that are operable, when executed by the one or more processors, to cause the one or more processors to perform operations including: receiving, from a base station of a wireless network, a group paging message including an identifier of a multicast session of the wireless network; inferring, based on the group paging message, that an activation state of the multicast session is an activated state; determining that a current Radio Resource Control (RRC) state of the UE device is an inactive RRC state; selecting, based on the group paging message and the current RRC state of the UE device, a RRC state of the UE device for receiving data from the multicast session; and receiving data from the multicast session according to the selected RRC state.

Implementations of this aspect can include one or more of the following features.

In some implementations, selecting the RRC state of the UE device for receiving data from the multicast session can include: determining that at least one of (i) the UE device has received Point-to-Multipoint (PTM) configuration information for the multicast session from the wireless network or (ii) the wireless network has indicated to the UE device that the PTM configuration information will be provided to the UE device; and selecting the inactive RRC state for receiving data from the multicast session.

In some implementations, selecting the RRC state of the UE device for receiving data from the multicast session can include: determining that (i) the UE device has not received Point-to-Multipoint (PTM) configuration information the multicast session from the wireless network and (ii) the wireless network has not indicated to the UE device that the PTM configuration information will be provided to the UE device; and selecting a connected RRC state for receiving data from the multicast session.

In some implementations, the operations can further include: receiving, from the base station of the wireless network subsequent to receiving the group paging message, a second group paging message including the identifier of the multicast session; inferring, based on the second group paging message, that the activation state of the multicast session of the wireless network has transitioned to a deactivated state, and terminating a receipt of data from the multicast session.

In some implementations, the operations can further include: receiving, from the base station of the wireless network prior to receiving the group paging message, a second group paging message including the identifier of the multicast session; inferring, based on the second group paging message, that the activation state of the multicast session of the wireless network has transitioned to a deactivated state, and terminating a receipt of data from the multicast session.

In accordance with another aspect of the present disclosure, a UE device includes one or processors and one or more storage devices on which are stored instructions that are operable, when executed by the one or more processors, to cause the one or more processors to perform operations including: receiving, from a base station of a wireless network, Point-to-Multipoint (PTM) configuration information for a multicast session of the wireless network; inferring, based on the PTM configuration information, that an activation state of the multicast session is an activated state; determining that a current Radio Resource Control (RRC) state of the UE device is an inactive RRC state; and receiving data from the multicast session according to the inactive RRC state.

Implementations of this aspect can include one or more of the following features.

In some implementations, the PTM configuration information can be received from a Multicast Control Channel (MCCH).

In some implementations, the operations can further including: receiving a paging message from the base station, the paging message including instructions to the UE device to transition to a connected RRC state; and receiving data from the multicast session according to the connected RRC state.

In some implementations, the operations can further include: receiving a paging message from the base station, the paging message indicating a preferred RRC state for the UE device; selecting, based on the paging message, a RRC state of the UE device for receiving data from the multicast session; and receiving data from the multicast session according to the selected RRC state.

In some implementations, the preferred RRC state for the UE device can be the inactive RRC state. Further, the selected RRC state can be the inactive RRC state.

In some implementations, the preferred RRC state for the UE device can be the connected RRC state. Further, the selected RRC state can be the connected RRC state.

In accordance with another aspect of the present disclosure, a UE device includes one or processors and one or more storage devices on which are stored instructions that are operable, when executed by the one or more processors, to cause the one or more processors to perform operations including: receiving, from a base station of a wireless network, information indicating an activation state of multicast session of the wireless network, where the information is included in at least one of: Point-to-Multipoint (PTM) configuration information for the multicast session provided to the UE by the wireless network via a Multicast Control Channel (MCCH), Downlink Control Information (DCI) provided to the UE by the wireless network, or a MCCH notification message; determining, based on the information that an activation state of the multicast session is an activated state; determining that a current Radio Resource Control (RRC) state of the UE device is an inactive RRC state; and receiving data from the multicast session according to the inactive RRC state.

Implementations of this aspect can include one or more of the following features.

In some implementations, the operations can further include: receiving a paging message from the base station, the paging message including instructions to the UE device to transition to a connected RRC state; and receiving data from the multicast session according to the connected RRC state.

In some implementations, the operations can further include: receiving a paging message from the base station, the paging message indicating a preferred RRC state for the UE device; selecting, based on the paging message, a RRC state of the UE device for receiving data from the multicast session; and receiving data from the multicast session according to the selected RRC state.

In some implementations, the preferred RRC state for the UE device can be the inactive RRC state. Further, the selected RRC state can be the inactive RRC state.

In some implementations, the preferred RRC state for the UE device can be the connected RRC state. Further, the selected RRC state can be the connected RRC state.

In accordance with another aspect of the present disclosure, a UE device includes one or processors and one or more storage devices on which are stored instructions that are operable, when executed by the one or more processors, to cause the one or more processors to perform operations including: receiving, from a base station of a wireless network, a paging message including first data indicating that an activation state of a multicast session of the wireless network has changed; retrieving, from the wireless network, additional information indicating the activation state of multicast session, where the additional information is included in Point-to-Multipoint (PTM) configuration information for the multicast session provided to the UE by the wireless network via a Multicast Control Channel (MCCH); determining, based on the additional information, that the activation state of the multicast session is an activated state; determining that a current Radio Resource Control (RRC) state of the UE device is an inactive RRC state; and receiving data from the multicast session according to the inactive RRC state.

Implementations of this aspect can include one or more of the following features.

In some implementations, the paging message can further include second data indicating an identifier of the multicast session.

In some implementations, the operations can further include: receiving a paging message from the base station, the paging message including instructions to the UE device to transition to a connected RRC state; and receiving data from the multicast session according to the connected RRC state.

In some implementations, the operations can further include: receiving a paging message from the base station, the paging message indicating a preferred RRC state for the UE device; selecting, based on the paging message, a RRC state of the UE device for receiving data from the multicast session; and receiving data from the multicast session according to the selected RRC state.

In some implementations, the preferred RRC state for the UE device can be the inactive RRC state. Further, the selected RRC state can be the inactive RRC state.

In some implementations, the preferred RRC state for the UE device can be the connected RRC state. Further, the selected RRC state can be the connected RRC state.

In accordance with another aspect of the present disclosure, an apparatus includes one or more baseband processors configured to perform any of the operations described herein.

In accordance with another aspect of the present disclosure, a method includes any of the operations described herein.

In accordance with another aspect of the present disclosure, a non-transitory computer storage medium is encoded with instructions that, when executed by one or more processors, cause the one or more processors to perform any of the operations described herein.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 is a diagram of an example wireless network.

FIG. 2A is a diagram of an example system for exchanging data via a multicast session.

FIG. 2B is a diagram of an example process for exchanging data via a multicast session.

FIGS. 3A-3C are flowcharts of example processes for exchanging data via a multicast session.

FIGS. 4A-4E are flowcharts of further example processes for exchanging data via a multicast session.

FIG. 5 is a diagram of an example user equipment (UE).

FIG. 6 is a diagram of an example access node.

### DETAILED DESCRIPTION

This disclosure sets forth various techniques for facilitating Multicast and Broadcast Services (MBS) on a wireless network, such as a cellular network.

In an example implementation, a base station (BS) of a wireless network can transmit data to multiple user equipment (UE) devices concurrently via a multicast session (e.g., a communications session in which at least some of the same data is transmitted to each of the UE devices concurrently). Further, based on information obtained from the BS, each of the UE devices can determine whether to receive data from the multicast session according to a particular Radio Resource Control (RRC) state, such as an inactive RRC state or a connected RRC state. Further, based on information obtained from the BS, each of the UE devices can determine whether to selectively discontinue receiving data from the multicast session.

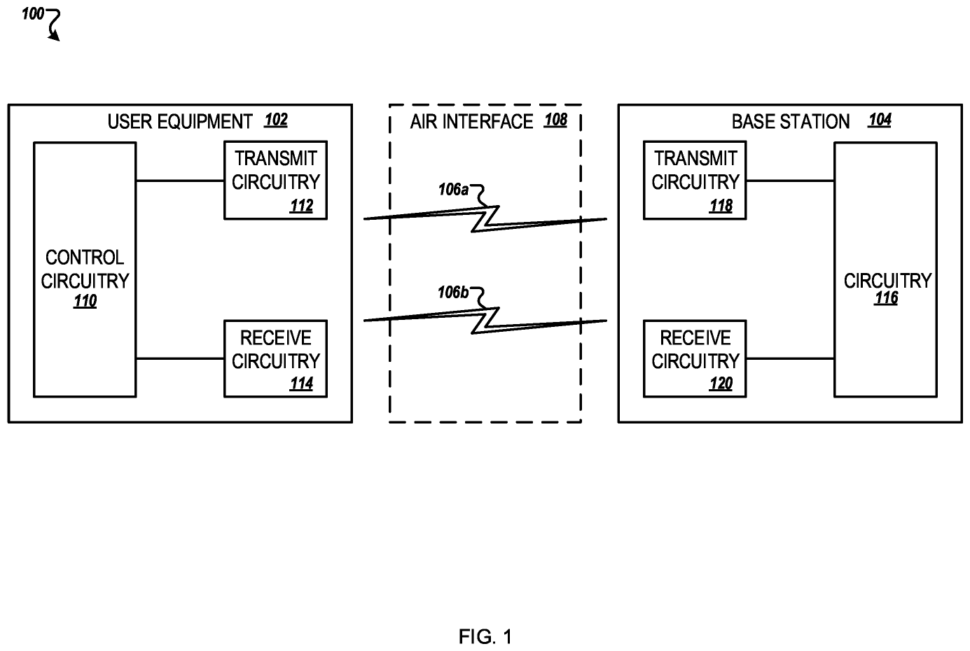

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be an E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. As an example, the control circuitry 110 can be configured to receive data from a wireless network (e.g., the BS 104) via a multicast session. As another example, the control circuitry 110 can be configured to determine a RRC state of the UE device 102 for receiving the data from the multicast session. As another example, the control circuitry 110 can be configured to determine whether to discontinue receiving data via the multicast session.

The transmit circuitry 112 can perform various operations described in this specification. For example, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can receive data from a wireless network (e.g., the BS 104) regarding establishing a multicast session and receiving data from the wireless network via the multicast session. As another example, the receive circuitry 114 can receive data (e.g., signaling information, notifications, messages, etc.) from the wireless network that allow the UE 102 (e.g., using the control circuitry 110) to determine a RRC state for receiving the data from the multicast session. As another example, the receive circuitry 114 can receive data (e.g., signaling information, notifications, messages, etc.) from the wireless network that allow the UE 102 (e.g., using the control circuitry 110) to determine whether to discontinue receiving data from the multicast session. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

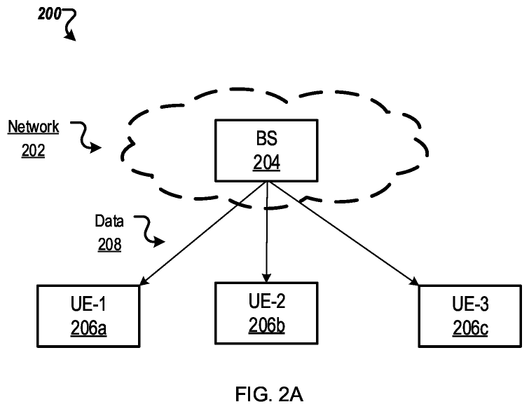

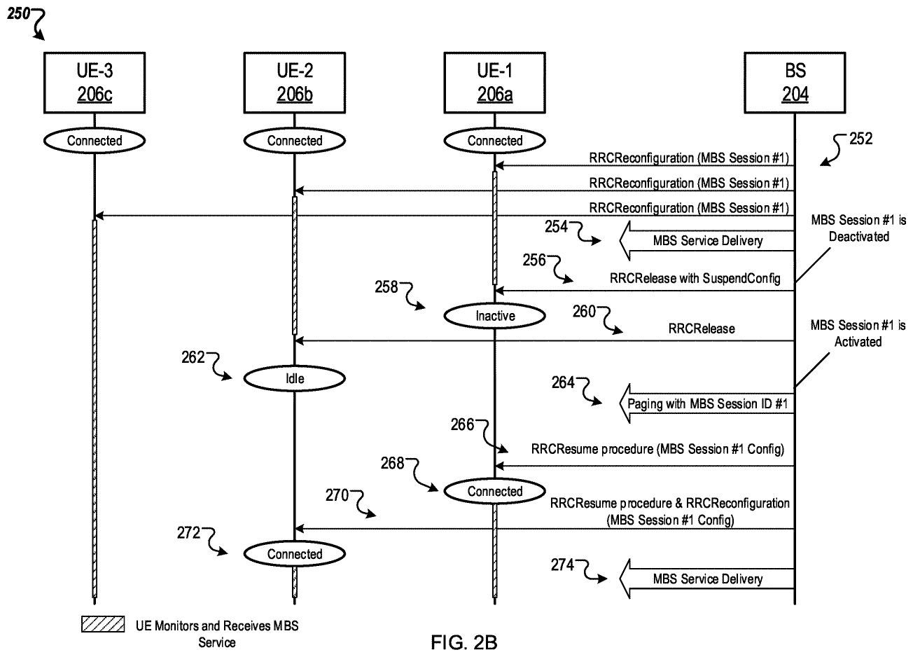

In general, BS of a wireless network can transmit data to multiple UE devices concurrently via a multicast session (e.g., a communications session in which at least some of the same data is transmitted to each of the UE devices concurrently). As an example, FIG. 2A shows an example system 200 having a wireless network 202 with a BS 204, and three UE devices 206a-206c (“UE-1,” “UE-2,” and “UE-3”). The BS 204 can establish a multicast session with the UE devices 206a-206c and transmit at least some of the same data 208 to each of the UE devices 206a-206c concurrently using the multicast session.

In general, the wireless network 202 can be similar to the network 100 shown in FIG. 1. Further, the BS 204 can be similar to the BS 104 shown in FIG. 1. Further still, each of the UE devices 206a-206c can be similar to the UE 102 shown in FIG. 1.

In some implementations, based on information obtained from the BS, each of the UE devices can determine whether to receive data from the multicast session according to a particular Radio Resource Control (RRC) state, whereby the UE device may access and use a particular set of radio resources. For instance, according to 5G NR communication standards, RRC states can include an “inactive” RRC state, a “connected” RRC state, and an “idle” RRC state.

In some cases (e.g., according to 5G NR communication standards, such as the 3GPP 5G NR Release 17 and/or Release 18 communications standards, incorporated herein by reference in their entirety), an “inactive” RRC state may be referred to as an RRC Inactive Mode or “RRC_INACTIVE” mode.

In some cases (e.g., according to 5G NR communication standards, such as the 3GPP 5G NR Release 17 and/or Release 18 communications standards), a “connected” RRC state may be referred to as an RRC Connected Mode or “RRC_CONNECTED” mode.

In some cases (e.g., according to 5G NR communication standards, such as the 3GPP 5G NR Release 17 and/or Release 18 communications standards), an “idle” RRC state may be referred to as an RRC Idle Mode or “RRC_IDLE” mode.

In some implementations, based on information obtained from the BS, each of the UE devices can also determine whether to selectively discontinue receiving data from the multicast session. For example, a UE device can receive data from a multicast session (e.g., according to an inactive RRC state or a connected RRC state). Upon receiving certain information from the BS, the UE device can selectively refrain from receiving further data from the multicast session.

An example process 250 for establishing a multicast session and transmitting data using a multicast session is shown in FIG. 2B. In this example process, the BS 204 of the wireless network 202 establishes a multicast session with three UE devices 206a-206c (e.g., via the BS 204), and transmits data to each of the UE devices 206a-206c concurrently using the multicast session.

In the process 250, each of the UE devices 206a-206c is initially in a connected RRC state. Further, the BS 204 transmits a notification to each of the UE devices 206a-206c with MBS configuration information for the multicast session (e.g., an “RRCReconfiguration” message) (operation 252). In some implementations, the MBS configuration information can include an identifier that uniquely identifies the multicast session from other multicast sessions (here, “MBS Session #1”).

Each of the UE devices 206a-206c joins the multicast session based on the received MBS configuration information, and monitors the multicast session for MBS service. During this time, the wireless network (e.g., via the BS 204) can transmit data via the multicast session, such that the data is received by each of the UE devices 206a-206c (operation 254).

Further, the wireless network can selectively deactivate the multicast session, and release one or more of the UE devices 206a-206c into a different RRC state (e.g., an inactive RRC state or an idle RRC state).

As an example, referring to FIG. 2B, the wireless network (e.g., via the BS 204) can transmit a message to the UE device 206a instructing the UE device 206a to transition to an inactive RRC state (e.g., an “RRCRelease” message with “SuspendConfig” parameter) (operation 256). In response to receiving the message, the UE device 206a transitions from the connected RRC state to the inactive RRC state, and discontinues monitoring the multicast session of MBS service (operation 258).

As another example, referring to FIG. 2B, the wireless network (e.g., via the BS 204) can transmit a message to the UE device 206b instructing the UE device 206b to transition to an idle RRC state (e.g., an “RRCRelease” message) (operation 260). In response to receiving the message, the UE device 206b transitions from the connected RRC state to the idle RRC state, and discontinues monitoring the multicast session of MBS service (operation 262).

Further, the wireless network can selectively reactivate the multicast session, such that data can again be transmitted to one or more of the UE devices 206a-206c concurrently via the multicast session.

As an example, referring to FIG. 2B, the wireless network (e.g., via the BS 204) can transmit a paging message to each of the UE devices 206a-206c including the identifier of the multicast session and an indication that the multicast session has been reactivated (operation 264). The paging message can be transmitted to some or all of the UE devices 206a-206c concurrently (e.g., as a group, rather than to one or more or the UE devices 206a-206c individually). For example, in some implementations, the paging message can be concurrently transmitted to each of the UE devices that are in the idle RRC state and/or the inactive RRC state (e.g., the UE devices 206a and 206b). Nevertheless, in some implementations, the paging message can be transmitted to some or all of the UE devices 206a-206c individually.

Further, the wireless network (e.g., via the BS 204) can transmit a message to the UE device 206a instructing the UE device 206a to transition back to the connected RRC state (e.g., a message initiating an “RRCResume” procedure and including the identifier of the multicast session) (operation 266). In response to receiving the message, the UE device 206a transitions from the inactive RRC state to the connected RRC state, and monitors the multicast session of MBS service (operation 268)

Further, the wireless network (e.g., via the BS 204) can transmit a message to the UE device 206b instructing the UE device 20ba to transition back to the connected RRC state (e.g., a message initiating a “RRCResume” procedure and/or a “RRCReconfiguration”message, with the identifier of the multicast session) (operation 270). In response to receiving the message, the UE device 206b transitions from the idle RRC state to the connected RRC state, and monitors the multicast session of MBS service (operation 272).

Further, the wireless network (e.g., via the BS 204) can transmit data via the multicast session, such that the data is received by each of the UE devices 206a-206c (operation 274).

In the example process shown in FIG. 2B, a UE device receives data from a multicast session in a connected RRC state (e.g., by transitioning from an inactive or idle RRC state to a connected RRC state, prior to receiving data from the multicast session). However, in some implementation, an UE device can also receive data from a multicast session in another RRC state, such an inactive RRC state.

For example, in some implementations, upon receiving indication that a wireless network is activating a multicast session, the UE device can determine whether to received data from the multicast session in an inactive RRC state or in a connected RRC state. Further, the UE can determine whether to continue receiving data from the multicast session (e.g., according an inactive RRC state and/or in a connected RRC state), or to discontinue receiving data from the multicast session.

More specifically, the techniques described herein enable a UE device to adjust its operation according to at least three different use cases, based at least in part of on information received from a BS of a wireless network.

In a first example use case, when a UE device is in an inactive RRC state and the wireless network has changed the activation state of a multicast session from an activated state to a deactivated state, the UE device can determine whether to receive data from the multicast session according to a connected RRC state.

In a second example use case, when a UE device is in an inactive RRC state and the wireless network has changed the activation state of a multicast session from an activated state to a deactivated state, the UE device can determine whether to receive data from the multicast session according to the inactivate RRC state.

In a third example use case, when a UE device is in an inactive RRC state and the wireless network has changed the activation state of a multicast session from a deactivated state to an activated state, the UE device can determine whether to discontinue receiving data from the the multicast session.

Example techniques for making these example determinations and other example determinations are described in further detail below.

### First Example(s)

In some implementations, a group paging notification (e.g., a paging notification transmitted from a BS to one or more UE devices concurrently) can include information indicating activation states of one or more multicast sessions. Further, the group paging notification can indicate an activation state of each multicast session individually (e.g., on a multicast session by multicast session basis). As an example, for each multicast session, a group paging notification can include: (i) an identifier for that multicast session (e.g., a Temporary Mobile Group Identity (TMGI) identifier associated with that multicast session), and (ii) an indication whether that multicast session is in an active or deactivated state.

Further, in some implementations, the paging notification can also indicate, for each multicast session, a preferred RRC state for an UE device to receive data from that multicast session.

For instance, an UE device can be in an inactive RRC state, and can receive a group paging notification transmitted by a BS to the UE device (and one or more additional UE devices) regarding a multicast session. As described above, the group paging notification can include an identifier for that multicast session (e.g., TMGI) and an indication whether that multicast session is in an active or deactivated state.

The UE device determines whether it has previously joined the multicast session. If so, the UE device determines whether the group paging notification indicates that the multicast session is in a deactivated state. If the group paging notification indicates that the multicast session is in a deactivated state, the UE discontinues receiving data from the multicast session.

However, if the group paging notification indicates that the multicast session is in an active state, the UE determines whether to receive data from the multicast session in a connected RRC state or in an inactive RRC state.

If the paging notification indicates a preferred RRC state for the UE device to receive data from that multicast session, the UE device selects its RRC state such that it matches the indicated preferred RRC state. For example, if the paging notification indicates that the inactive RRC state is the preferred RRC state, the UE receives data from the multicast session in the inactive RRC state. As another example, if the paging notification indicates that the connected RRC state is the preferred RRC state, the UE receives data from the multicast session in the connected RRC state instead (e.g., by resuming the RRC connection with the BS, such as by performing an “RRCResume” procedure as described with reference to FIG. 2B).

If the paging notification does not indicate a preferred RRC state for the UE device to receive data from that multicast session, the UE device selects its RRC state based on a determination whether (i) the UE device has received Point-to-Multipoint (PTM) configuration information for the multicast session from the wireless network or (ii) the wireless network has indicated to the UE device that the PTM configuration information will be provided to the UE device (e.g., via a control channel, such as a Multicast Control Channel (MCCH)). If either of the two are true (and the UE device is in an in activated RRC state), the UE receives data from the multicast session in the inactive RRC state. However, with neither of the two are true (and the UE device is an in inactive RRC), the UE receives data from the multicast session in the connected RRC state instead (e.g., by resuming the RRC connection with the BS, such as by performing an “RRCResume” procedure as described with reference to FIG. 2B).

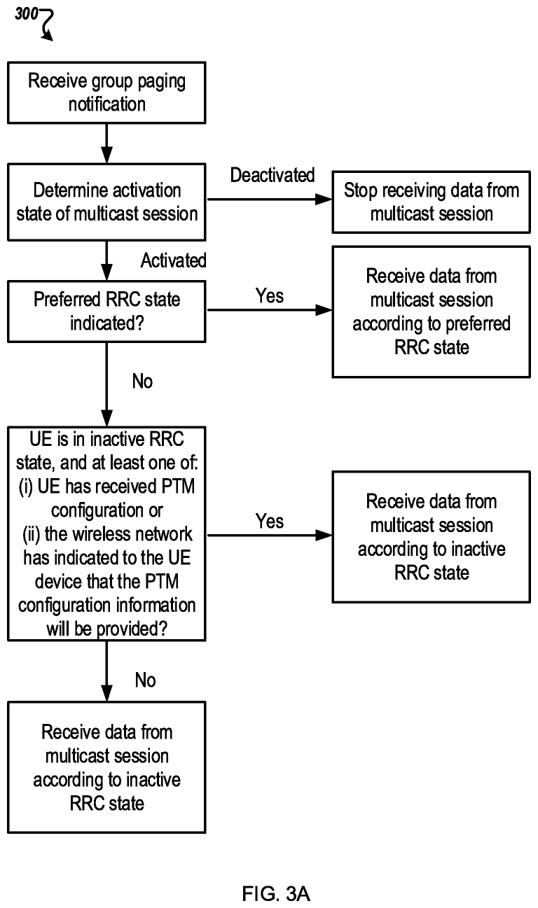

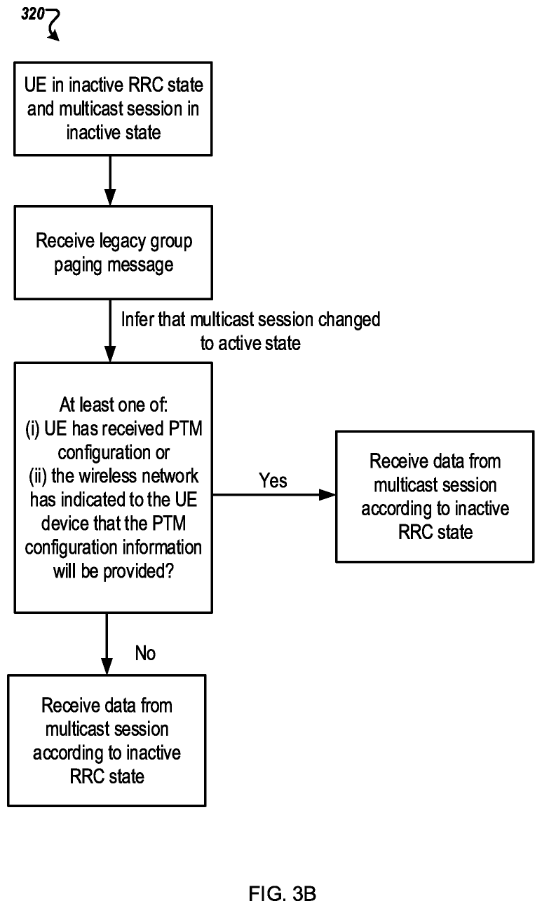

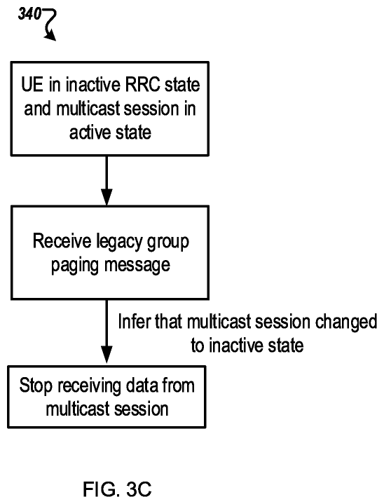

These example(s) are summarized in FIG. 3A as process 300.

### Second Example(s)

In some implementations, a UE device can determine an RRC state for receiving data from a multicast session based on a “legacy” group paging notification received from a wireless network (e.g., via a BS). Further in some implementations, a UE can determine whether to discontinue receiving data from a multicast session based on a legacy group notification received from the wireless network (e.g., via the BS). In some implementations, a legacy group paging notification can refer to a paging notification conforming with the 3GPP 5G NR Release 17 communication standards.

As an example, a UE device is in an inactive RRC state and is configured to receive data from a multicast session that is currently in a deactivated state. Upon receiving a legacy group paging notification identifying the multicast session (e.g., a legacy group paging notification including an identifier associated with the multicast session, such as a TMGI), the UE infers that the multicast session has changed to an active state. Based on this determination, the UE determines whether (i) the UE device has received PTM configuration information for the multicast session from the wireless network or (ii) the wireless network has indicated to the UE device that the PTM configuration information will be provided to the UE device (e.g., via a control channel, such as a MCCH). If either of the two are true, the UE receives data from the multicast session in the inactive RRC state. However, with neither of the two are true, the UE receives data from the multicast session in the connected RRC state instead (e.g., by resuming the RRC connection with the BS, such as by performing an “RRCResume” procedure as described with reference to FIG. 2B).

These example(s) are summarized in FIG. 3B as process 320.

As another example, a UE device is in an inactive RRC state and is receiving data from a multicast session that is currently in an active state. Upon receiving a legacy group paging notification identifying the multicast session (e.g., a legacy group paging notification including an identifier associated with the multicast session, such as a TMGI), the UE infers that the multicast session has changed to an inactivate state. Based on this determination, the UE device discontinues receiving data from the multicast session.

These example(s) are summarized in FIG. 3C as process 340.

In some implementations, a UE device can assume that the gap (e.g., a time gap) between the group paging notification for activation/deactivation purpose for the same multicast session (e.g., the same TGMI) should larger than a predefined value or gap.

In some implementations, for the UE device RRC state change for the multicast reception, the wireless network (e.g., via the BS) NW can use a UE device-specific paging message to trigger the UE device back to a connected RRC state. For example, if the UE device's operation is operating according to legacy communications standards (e.g., 3GPP 5G NR Release 17) when receiving UE device-specific Radio Access Network (RAN) paging, the UE device can trigger the RRCResume procedure. As another example, if the UE device is currently receiving data from the multicast session, the UE device can continue receiving data in a connected RRC state.

### Third Example(s)

In some implementations, a UE device that is in an inactive RRC state can receive PTM configuration information from a wireless network (e.g., via a BS) through a MCCH. Further, the UE device can determine an activation state of a multicast session based on information via the MCCH.

In some implementations, information received by a UE device through the MCCH can provide an implicit indication of the activation state of a multicast session. For example, a wireless network (via a BS) can provide the UE device with PTM configuration information only for activated multicast sessions (and not provide PTM configuration information for inactive multicast sessions). The UE device can infer whether a multicast session is in an active or deactivated state based on the receipt (or absence) of PTM configuration information for that multicast session. For example, upon receiving PTM configuration information for a particular multicast session (e.g., corresponding to a particular TMGI), the UE device can that the multicast session is in an active state. As another example, in the absence of PTM configuration information for a particular multicast session (e.g., corresponding to a particular TMGI), the UE device can that the multicast session is in a deactivated state.

In some implementations, information received by a UE device through the MCCH can provide an explicit indication of the activation state of a multicast session. For example, a wireless network (via a BS) can provide the UE device with information in a MCCH, such as PTM configuration information, Downlink Control Information (DCI), and/or an MCCH notification message. The PTM configuration information, DCI, and/or MCCH notification message can an expressly indicate, for each multicast session, an identifier for that multicast session (e.g., TMGI) and an indication whether that multicast session is in an active or deactivated state.

In some implementations, upon the UE device receiving a paging notification indicating that a particular multicast session have changed states, the UE device can retrieve information from a MCCH (e.g., PTM configuration information, DCI, MCCH notification messages, etc.) including an indication whether the multicast session is in an active or deactivated state.

In each of these examples, the UE device receives data from the multicast session in an inactive RRC state in accordance with the information received from the MCCH and/or PTM configuration information.

In some implementations, the UE device can change its RRC state to receive data from multicast session.

For example, a wireless network (via a BS) can transmits a UE device-specific paging message to the UE device to trigger the UE device back to connected RRC state (e.g., to cause the UE device to perform the RRCResume procedure).

As another example, a wireless network (via a BS) can indicate to a UE device the preferred RRC state for that UE device (e.g., using one or more of the group paging notifications described above). If an inactive RRC state is preferred, a UE device that is currently configured for multicast reception in the inactive RRC state can continue receiving data in an inactive RRC state. Otherwise, the UE device can change to the connected RRC state to receive data from the multicast session (e.g., by triggering the RRCResume procedure).

### Fourth Example(s)

In some implementations, a UE device can determine that a multicast session is in an activated state (e.g., based on one or more of the techniques described herein). In response, the UE device can determine a RRC state for receiving data from the multicast session according to one or more criteria.

As an example, the UE device can determine a radio quality metric for the UE device (e.g., representing the quality of signals transmitted and/or received by the radio of the UE device), and compare the radio quality metric to a threshold value. If the radio quality metric is less than the threshold value, the UE device can select a first RRC state for receiving data from the multicast session (e.g., a connected RRC state). Otherwise, the UE device can select a second RRC state for receiving data from the multicast session (e.g., an inactive RRC state).

As another example, UE device can determine the occurrence of a particular event, and in response, select a corresponding RRC state for receiving data from the multicast session. As an example, the UE device can select a particular RRC state (e.g., a connected RRC state) when the UE device is performing measurements on one or more neighboring cells of the wireless network.

As another example, the UE device can select a RRC state for receiving data from the multicast session based on preference data (e.g., stored by and/or retrieved by the UE device). For example, the preference data can specify that the UE device receive data from a multicast session according to a particular preferred RRC state. Upon determining that a multicast session has been activated, the UE device can receive data from the multicast session in accordance with the preferred RRC state.

### Example Methods

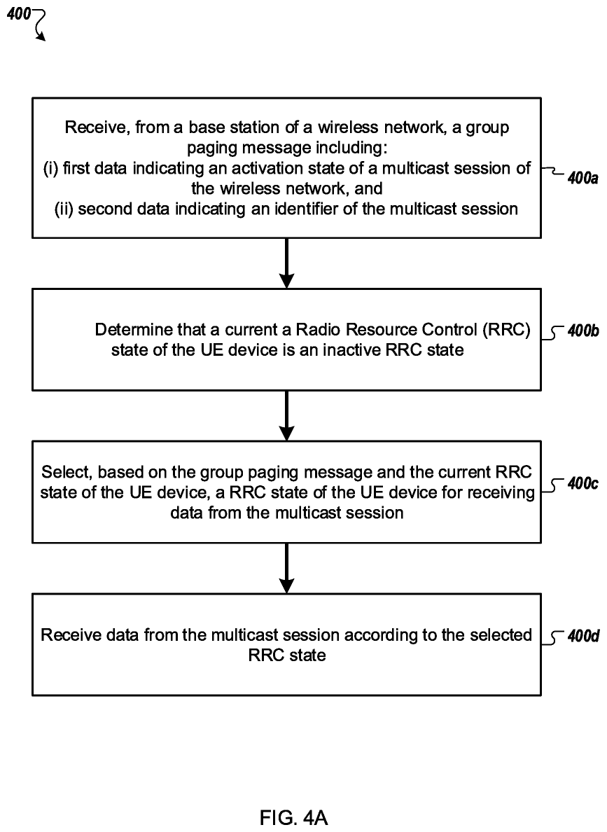

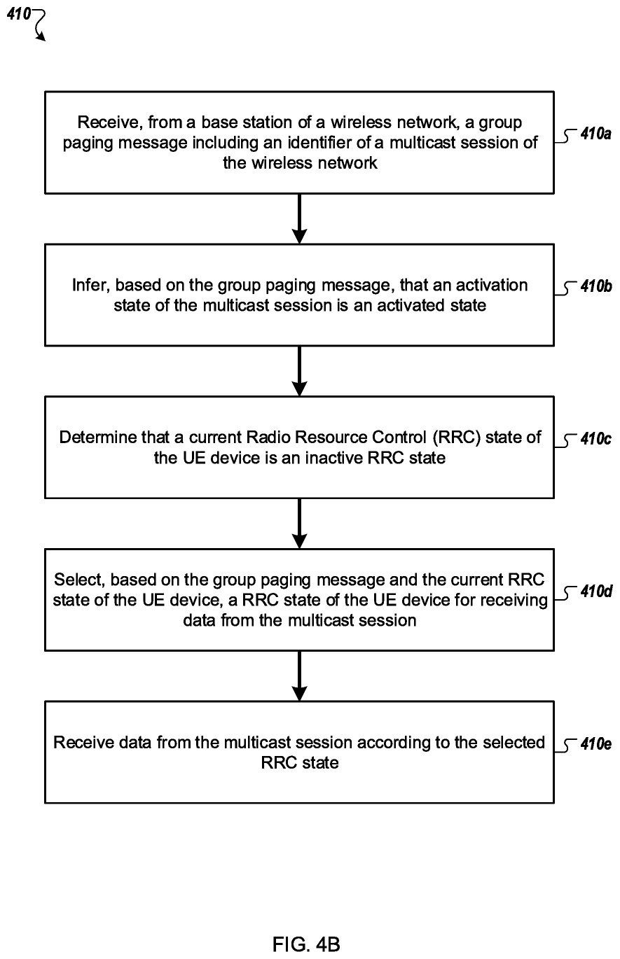

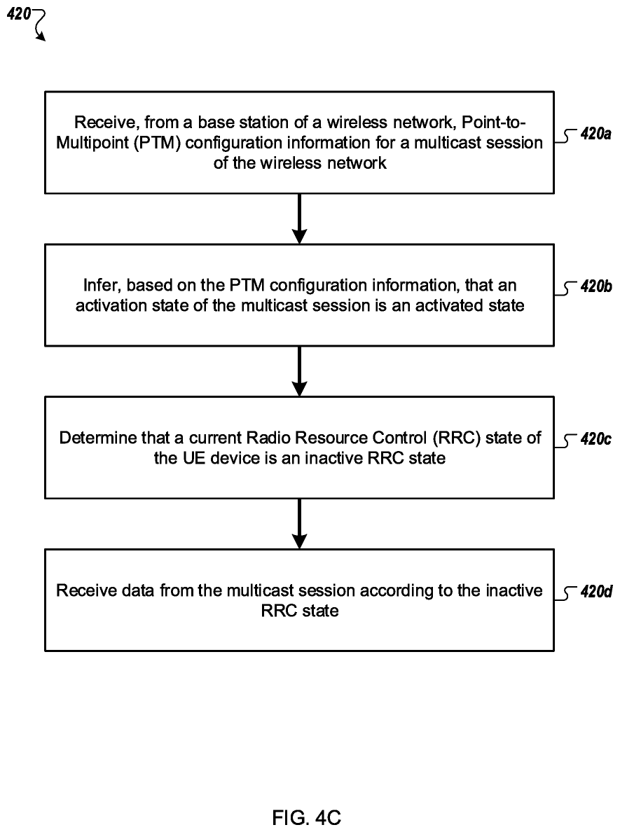

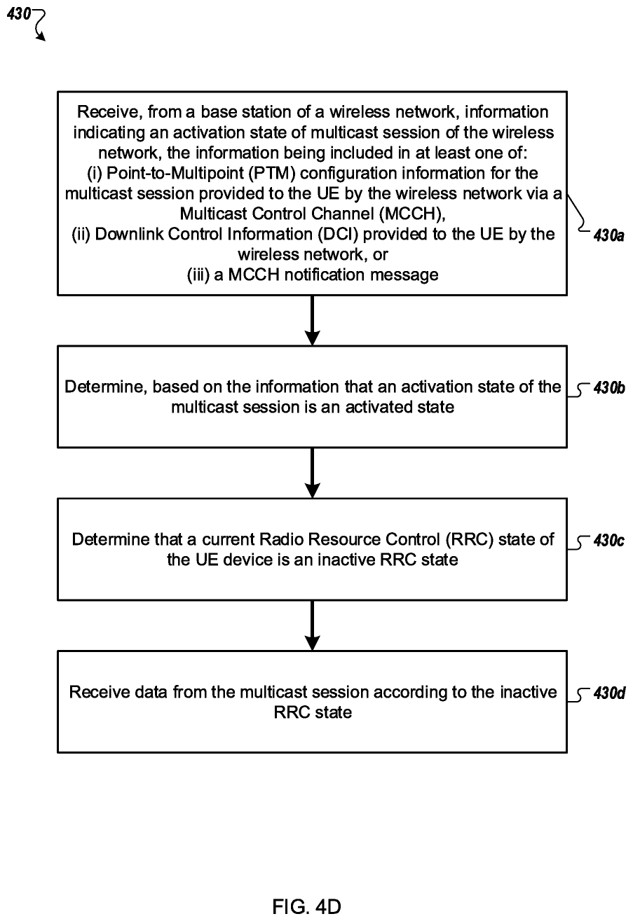

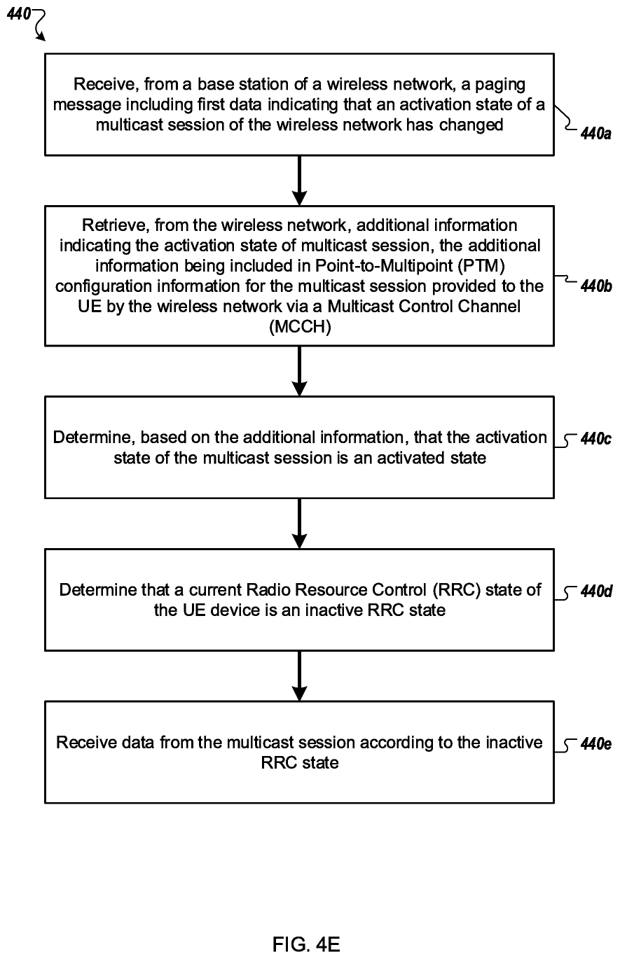

FIG. 4A illustrates a flowchart of an example method 400, according to some implementations. For clarity of presentation, the description that follows generally describes method 400 in the context of the other figures in this description. For example, method 400 can be performed by the UE 102 shown in FIG. 1 and/or one or more of the UE devices 206a-206c shown in FIG. 2A. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

According to the method 400, a UE device receives, from a base station of a wireless network, a group paging message (block 400a). The group paging message includes first data indicating an activation state of a multicast session of the wireless network, and second data indicating an identifier of the multicast session.

The UE device determines that a current a Radio Resource Control (RRC) state of the UE device is an inactive RRC state (block 400b).

The UE device selects, based on the group paging message and the current RRC state of the UE device, a RRC state of the UE device for receiving data from the multicast session (block 400c).

The UE device receives data from the multicast session according to the selected RRC state (block 400d).

In some implementations, the group paging message can also include third data indicating a preferred RRC state for the UE device selected by the wireless network. Further, selecting the RRC state of the UE device for receiving data from the multicast session can include (i) determining that the activation state of the multicast session is an activated state, (ii) determining that preferred RRC state is an inactive RRC state, and (iii) selecting the inactive RRC state for receiving data from the multicast session.

In some implementations, the group paging message can also include third data indicating a preferred RRC state for the UE device selected by the wireless network. Further, selecting the RRC state of the UE device for receiving data from the multicast session can include (i) determining that the activation state of the multicast session is an activated state, (ii) determining that preferred RRC state is a connected RRC state, and (iii) selecting the connected RRC state for receiving data from the multicast session.

In some implementations, selecting the RRC state of the UE device for receiving data from the multicast session can include determining that the activation state of the multicast session is an activated state, and determining an absence of data indicating a preferred RRC state for the UE device in the group paging message. Further, a determination can be made that at least one of (i) the UE device has received Point-to-Multipoint (PTM) configuration information for the multicast session from the wireless network or (ii) the wireless network has indicated to the UE device that the PTM configuration information will be provided to the UE device. Based on these determinations, the inactive RRC state can be selected for receiving data from the multicast session.

In some implementations, selecting the RRC state of the UE device for receiving data from the multicast session can include determining that the activation state of the multicast session is an activated state, and determining an absence of data indicating a preferred RRC state for the UE device in the group paging message. Further, a determination can be made that (i) the UE device has not received Point-to-Multipoint (PTM) configuration information for the multicast session from the wireless network and (ii) the wireless network has not indicated to the UE that the PTM configuration information will be provided to the UE device. Based on these determinations, a connected RRC state can be selected for receiving data from the multicast session.

In some implementations, the UE device can also receive, from the base station of the wireless network, a second group paging message indicating that the activation state of the multicast session of the wireless network is a deactivated state. In response, the UE device can determine a receipt of data from the multicast session.

FIG. 4B illustrates a flowchart of an example method 410, according to some implementations. For clarity of presentation, the description that follows generally describes method 410 in the context of the other figures in this description. For example, method 410 can be performed by the UE 102 shown in FIG. 1 and/or one or more of the UE devices 206a-206c shown in FIG. 2A. It will be understood that method 410 can be performed, for example, by any suitable system, environment, software, hardware, or a combination of systems, environments, software, and hardware, as appropriate. In some implementations, various steps of method 410 can be run in parallel, in combination, in loops, or in any order.

According to the method 410, a UE device receives, from a base station of a wireless network, a group paging message including an identifier of a multicast session of the wireless network (block 410a).

The UE device infers, based on the group paging message, that an activation state of the multicast session is an activated state (block 410b).

The UE device determines that a current Radio Resource Control (RRC) state of the UE device is an inactive RRC state (block 410c).

The UE device selects, based on the group paging message and the current RRC state of the UE device, a RRC state of the UE device for receiving data from the multicast session (block 410d).

The UE device receives data from the multicast session according to the selected RRC state (block 410e).

In some implementations, selecting the RRC state of the UE device for receiving data from the multicast session can including determine that at least one of (i) the UE device has received Point-to-Multipoint (PTM) configuration information for the multicast session from the wireless network or (ii) the wireless network has indicated to the UE device that the PTM configuration information will be provided to the UE device. Based on this determination, the UE device can select the inactive RRC state for receiving data from the multicast session.

In some implementations, selecting the RRC state of the UE device for receiving data from the multicast session can include determining that (i) the UE device has not received Point-to-Multipoint (PTM) configuration information the multicast session from the wireless network and (ii) the wireless network has not indicated to the UE device that the PTM configuration information will be provided to the UE device. Based on this determination, the UE device can select a connected RRC state for receiving data from the multicast session.

In some implementations, the UE device can also receive, from the base station of the wireless network subsequent to receiving the group paging message, a second group paging message including the identifier of the multicast session. Further, the UE device can infer, based on the second group paging message, that the activation state of the multicast session of the wireless network has transitioned to a deactivated state. Based on this inference, the UE device can terminate a receipt of data from the multicast session.

In some implementations, the UE device can also receive, from the base station of the wireless network prior to receiving the group paging message, a second group paging message including the identifier of the multicast session,. Further, the UE can infer, based on the second group paging message, that the activation state of the multicast session of the wireless network has transitioned to a deactivated state. Based on this inference, the UE device can determine a receipt of data from the multicast session.

FIG. 4C illustrates a flowchart of an example method 420, according to some implementations. For clarity of presentation, the description that follows generally describes method 420 in the context of the other figures in this description. For example, method 420 can be performed by the UE 102 shown in FIG. 1 and/or one or more of the UE devices 206a-206c shown in FIG. 2A. It will be understood that method 4200 can be performed, for example, by any suitable system, environment, software, hardware, or a combination of systems, environments, software, and hardware, as appropriate. In some implementations, various steps of method 420 can be run in parallel, in combination, in loops, or in any order.

According to the method 420, a UE device receives, from a base station of a wireless network, Point-to-Multipoint (PTM) configuration information for a multicast session of the wireless network (block 420a).

The UE device infers, based on the PTM configuration information, that an activation state of the multicast session is an activated state (block 420b).

The UE device determines that a current Radio Resource Control (RRC) state of the UE device is an inactive RRC state (block 420c).

The UE device receives data from the multicast session according to the inactive RRC state (block 420d).

In some implementations, the PTM configuration information can be received from a Multicast Control Channel (MCCH).

In some implementations, the UE device can also receive a paging message from the base station, the paging message including instructions to the UE device to transition to a connected RRC state. In response, the UE device can receive data from the multicast session according to the connected RRC state.

In some implementations, the UE device can also receive a paging message from the base station, the paging message indicating a preferred RRC state for the UE device. The UE device can select, based on the paging message, a RRC state of the UE device for receiving data from the multicast session. Further, the UE device can receive data from the multicast session according to the selected RRC state.

In some implementations, the preferred RRC state for the UE device can be the inactive RRC state. Further, the selected RRC state is the inactive RRC state.

In some implementations, the preferred RRC state for the UE device can be the connected RRC state. Further, the selected RRC state can be the connected RRC state.

FIG. 4D illustrates a flowchart of an example method 430, according to some implementations. For clarity of presentation, the description that follows generally describes method 430 in the context of the other figures in this description. For example, method 430 can be performed by the UE 102 shown in FIG. 1 and/or one or more of the UE devices 206a-206c shown in FIG. 2A. It will be understood that method 430 can be performed, for example, by any suitable system, environment, software, hardware, or a combination of systems, environments, software, and hardware, as appropriate. In some implementations, various steps of method 430 can be run in parallel, in combination, in loops, or in any order.

According to the method 430, a UE device receives, from a base station of a wireless network, information indicating an activation state of multicast session of the wireless network (block 430a). The information is included in at least one of: (i) Point-to-Multipoint (PTM) configuration information for the multicast session provided to the UE by the wireless network via a Multicast Control Channel (MCCH), (ii) Downlink Control Information (DCI) provided to the UE by the wireless network, or (iii) a MCCH notification message.

The UE device determines, based on the information that an activation state of the multicast session is an activated state (block 430b).

The UE device determines that a current Radio Resource Control (RRC) state of the UE device is an inactive RRC state (block 430c).

The UE device receives data from the multicast session according to the inactive RRC state (block 430d).

In some implementations, the UE device can also receive a paging message from the base station, the paging message including instructions to the UE device to transition to a connected RRC state. In response, the UE device can receive data from the multicast session according to the connected RRC state.

In some implementations, the UE device can also receive a paging message from the base station, the paging message indicating a preferred RRC state for the UE device. The UE device can select based on the paging message, a RRC state of the UE device for receiving data from the multicast session. Further, the UE device can receive data from the multicast session according to the selected RRC state.

In some implementations, the preferred RRC state for the UE device can be the inactive RRC state. Further, the selected RRC state can be the inactive RRC state.

In some implementations, the preferred RRC state for the UE device can be the connected RRC state. Further, the selected RRC state can be the connected RRC state.

FIG. 4E illustrates a flowchart of an example method 440, according to some implementations. For clarity of presentation, the description that follows generally describes method 40 in the context of the other figures in this description. For example, method 440 can be performed by the UE 102 shown in FIG. 1 and/or one or more of the UE devices 206a-206c shown in FIG. 2A. It will be understood that method 440 can be performed, for example, by any suitable system, environment, software, hardware, or a combination of systems, environments, software, and hardware, as appropriate. In some implementations, various steps of method 440 can be run in parallel, in combination, in loops, or in any order.

According to the method 440, a UE device receives, from a base station of a wireless network, a paging message including first data indicating that an activation state of a multicast session of the wireless network has changed (block 440a).

The UE device retrieves, from the wireless network, additional information indicating the activation state of multicast session (block 440b). The additional information is included in Point-to-Multipoint (PTM) configuration information for the multicast session provided to the UE by the wireless network via a Multicast Control Channel (MCCH).

The UE device determines, based on the additional information, that the activation state of the multicast session is an activated state (block 440c).

The UE device determines that a current Radio Resource Control (RRC) state of the UE device is an inactive RRC state (block 440d).

The UE device receives data from the multicast session according to the inactive RRC state (block 440e).

In some implementations, the paging message can also include second data indicating an identifier of the multicast session.

In some implementations, the UE device can also receive a paging message from the base station, the paging message including instructions to the UE device to transition to a connected RRC state. Further, the UE device can receive data from the multicast session according to the connected RRC state.

In some implementations, the UE device can also receive a paging message from the base station, the paging message indicating a preferred RRC state for the UE device. The UE device can select, based on the paging message, a RRC state of the UE device for receiving data from the multicast session. Further, the UE can receive data from the multicast session according to the selected RRC state.

In some implementations, the preferred RRC state for the UE device can be the inactive RRC state. Further, the selected RRC state can be the inactive RRC state.

In some implementations, the preferred RRC state for the UE device can be the connected RRC state. Further, the selected RRC state can be the connected RRC state.

The example methods shown in FIGS. 4A-4E can be modified or reconfigured to include additional, fewer, or different steps (not shown in FIGS. 4A-4E), which can be performed in the order shown or in a different order.

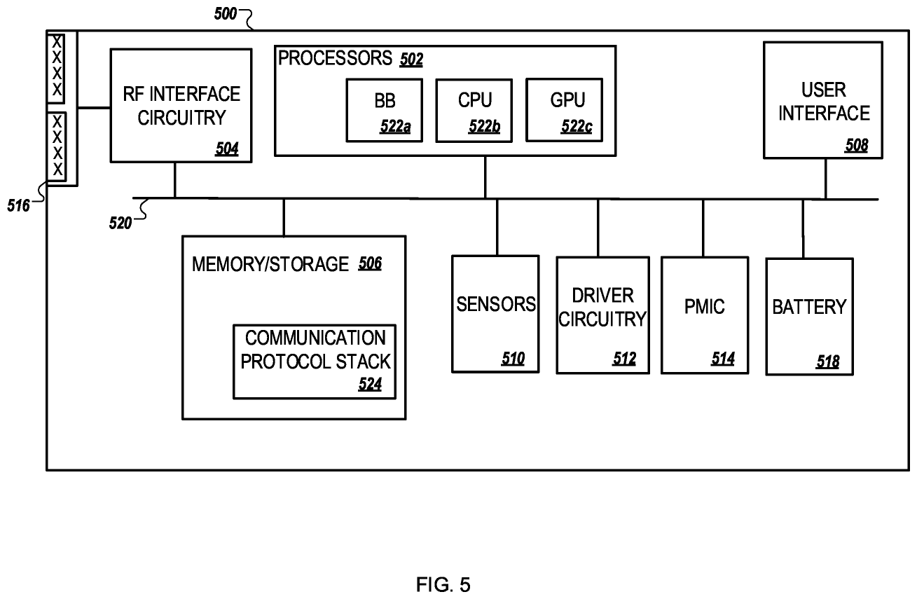

FIG. 5 illustrates a UE 500, according to some implementations. The UE 500 may be similar to and substantially interchangeable with UE 102 of FIG. 1 and/or UE devices 206a-206c to FIG. 2A.

The UE 500 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 500 may include processors 502, RF interface circuitry 504, memory/storage 506, user interface 508, sensors 510, driver circuitry 512, power management integrated circuit (PMIC) 514, antenna structure 516, and battery 518. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and different arrangement of the components shown may occur in other implementations.

The components of the UE 500 may be coupled with various other components over one or more interconnects 520, which may represent any type of interface, input/output, bus (local, system, or expansion), transmission line, trace, optical connection, etc. that allows various circuit components (on common or different chips or chipsets) to interact with one another.

The processors 502 may include processor circuitry such as, for example, baseband processor circuitry (BB) 522A, central processor unit circuitry (CPU) 522B, and graphics processor unit circuitry (GPU) 522C. The processors 502 may include any type of circuitry or processor circuitry that executes or otherwise operates computer-executable instructions, such as program code, software modules, or functional processes from memory/storage 506 to cause the UE 500 to perform operations as described herein.

In some implementations, the baseband processor circuitry 522A may access a communication protocol stack 524 in the memory/storage 506 to communicate over a 3GPP compatible network. In general, the baseband processor circuitry 522A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 504. The baseband processor circuitry 522A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 506 may include one or more non-transitory, computer-readable media that includes instructions (for example, communication protocol stack 524) that may be executed by one or more of the processors 502 to cause the UE 500 to perform various operations described herein. The memory/storage 506 include any type of volatile or non-volatile memory that may be distributed throughout the UE 500. In some implementations, some of the memory/storage 506 may be located on the processors 502 themselves (for example, L1 and L2 cache), while other memory/storage 506 is external to the processors 502 but accessible thereto via a memory interface. The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 516 and proceed to filter and amplify (with a low-noise amplifier) the signal. The signal may be provided to a receiver of the transceiver that downconverts the RF signal into a baseband signal that is provided to the baseband processor of the processors 502.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 516. In various implementations, the RF interface circuitry 504 may be configured to transmit/receive signals in a manner compatible with NR access technologies.

The antenna 516 may include antenna elements to convert electrical signals into radio waves to travel through the air and to convert received radio waves into electrical signals. The antenna elements may be arranged into one or more antenna panels. The antenna 516 may have antenna panels that are omnidirectional, directional, or a combination thereof to enable beamforming and multiple input, multiple output communications. The antenna 516 may include microstrip antennas, printed antennas fabricated on the surface of one or more printed circuit boards, patch antennas, phased array antennas, etc. The antenna 516 may have one or more panels designed for specific frequency bands including bands in FR1 or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensor circuitry 510 and control and allow access to sensor circuitry 510, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processors 502, the PMIC 514 may control power-source selection, voltage scaling, battery charging, or DC-to-DC conversion.

In some implementations, the PMIC 514 may control, or otherwise be part of, various power saving mechanisms of the UE 500. A battery 518 may power the UE 500, although in some examples the UE 500 may be mounted deployed in a fixed location, and may have a power supply coupled to an electrical grid. The battery 518 may be a lithium ion battery, a metal-air battery, such as a zinc-air battery, an aluminum-air battery, a lithium-air battery, and the like. In some implementations, such as in vehicle-based applications, the battery 518 may be a typical lead-acid automotive battery.

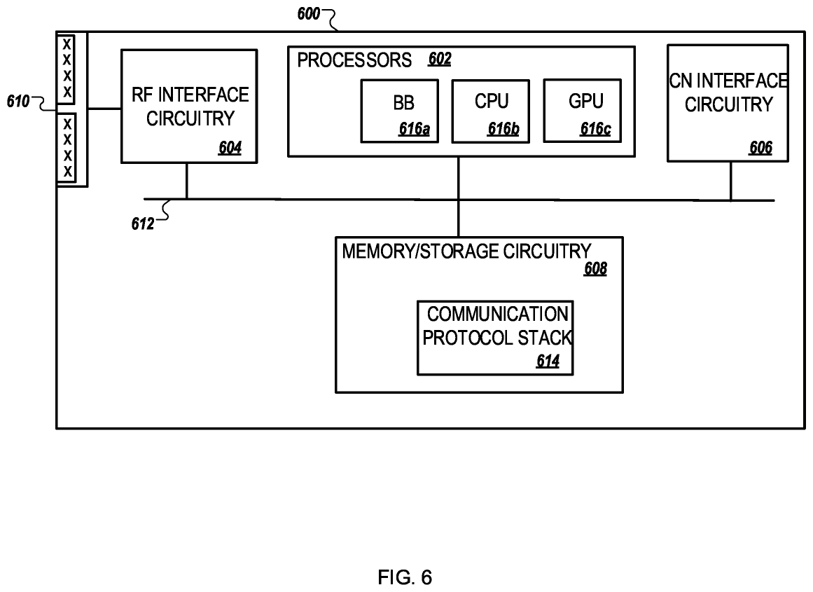

FIG. 6 illustrates an access node 600 (e.g., a base station or gNB), according to some implementations. The access node 600 may be similar to and substantially interchangeable with BS 104 shown in FIG. 1 and/or BS 204 shown in FIG. 2A. The access node 600 may include processors 602, RF interface circuitry 604, core network (CN) interface circuitry 606, memory/storage circuitry 608, and antenna structure 610.

The components of the access node 600 may be coupled with various other components over one or more interconnects 612. The processors 602, RF interface circuitry 604, memory/storage circuitry 608 (including communication protocol stack 614), antenna structure 610, and interconnects 612 may be similar to like-named elements shown and described with respect to FIG. 5. For example, the processors 602 may include processor circuitry such as, for example, baseband processor circuitry (BB) 616A, central processor unit circuitry (CPU) 616B, and graphics processor unit circuitry (GPU) 616C.

The CN interface circuitry 606 may provide connectivity to a core network, for example, a 5th Generation Core network (5GC) using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (e.g., an eNB). According to various implementations, the access node 600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 600 may be implemented as one or more software entities running on server computers as part of a virtual network, which may be referred to as a CRAN and/or a virtual baseband unit pool (vBBUP). In V2X scenarios, the access node 600 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### FURTHER EXAMPLES

In the following sections, further exemplary embodiments are provided.

Example A1 includes a UE device comprising one or processors and one or more storage devices on which are stored instructions that are operable, when executed by the one or more processors, to cause the one or more processors to perform operations comprising: receiving, from a base station of a wireless network, a group paging message comprising: first data indicating an activation state of a multicast session of the wireless network, and second data indicating an identifier of the multicast session; determining that a current a Radio Resource Control (RRC) state of the UE device is an inactive RRC state; selecting, based on the group paging message and the current RRC state of the UE device, a RRC state of the UE device for receiving data from the multicast session; and receiving data from the multicast session according to the selected RRC state.

Example A2 includes the UE device of Example A1. Further, the group paging message further comprises third data indicating a preferred RRC state for the UE device selected by the wireless network, and wherein selecting the RRC state of the UE device for receiving data from the multicast session comprises: determining that the activation state of the multicast session is an activated state, determining that preferred RRC state is an inactive RRC state, and selecting the inactive RRC state for receiving data from the multicast session.

Example A3 includes the UE device of any of Examples A1 and A2. Further, the group paging message further comprises third data indicating a preferred RRC state for the UE device selected by the wireless network, and wherein selecting the RRC state of the UE device for receiving data from the multicast session comprises: determining that the activation state of the multicast session is an activated state, determining that preferred RRC state is a connected RRC state, and selecting the connected RRC state for receiving data from the multicast session.

Example A4 includes the UE device of any of Examples A1-A3. Further, selecting the RRC state of the UE device for receiving data from the multicast session comprises: determining that the activation state of the multicast session is an activated state; determining an absence of data indicating a preferred RRC state for the UE device in the group paging message; determining that at least one of (i) the UE device has received Point-to-Multipoint (PTM) configuration information for the multicast session from the wireless network or (ii) the wireless network has indicated to the UE device that the PTM configuration information will be provided to the UE device, and selecting the inactive RRC state for receiving data from the multicast session.

Example A5 includes the UE device of any of Examples A1-A4. Further, selecting the RRC state of the UE device for receiving data from the multicast session comprises: determining that the activation state of the multicast session is an activated state; determining an absence of data indicating a preferred RRC state for the UE device in the group paging message; determining that (i) the UE device has not received Point-to-Multipoint (PTM) configuration information for the multicast session from the wireless network and (ii) the wireless network has not indicated to the UE that the PTM configuration information will be provided to the UE device; and selecting a connected RRC state for receiving data from the multicast session.

Example A6 includes the UE device of any of Examples A1-A5. Further, the operations further comprise: receiving, from the base station of the wireless network, a second group paging message indicating that the activation state of the multicast session of the wireless network is a deactivated state; and terminating a receipt of data from the multicast session.

Example A7 includes an apparatus comprising one or more baseband processors configured to perform operations of any of Examples A1-A7.

Example A8 includes a method comprising the operations of any of Examples A1-A7.

Example A9 includes a non-transitory computer storage medium encoded with instructions that, when executed by one or more processors, cause the one or more processors to perform the operations of any of Example A1-A7.

Example B1 includes a UE device comprising one or processors and one or more storage devices on which are stored instructions that are operable, when executed by the one or more processors, to cause the one or more processors to perform operations comprising: receiving, from a base station of a wireless network, a group paging message comprising an identifier of a multicast session of the wireless network; inferring, based on the group paging message, that an activation state of the multicast session is an activated state; determining that a current Radio Resource Control (RRC) state of the UE device is an inactive RRC state; selecting, based on the group paging message and the current RRC state of the UE device, a RRC state of the UE device for receiving data from the multicast session; and receiving data from the multicast session according to the selected RRC state.

Example B2 includes the UE device of Example B1. Further, selecting the RRC state of the UE device for receiving data from the multicast session comprises: determining that at least one of (i) the UE device has received Point-to-Multipoint (PTM) configuration information for the multicast session from the wireless network or (ii) the wireless network has indicated to the UE device that the PTM configuration information will be provided to the UE device; and selecting the inactive RRC state for receiving data from the multicast session.

Example B3 includes the UE device of any of Examples B1 and B2. Further, selecting the RRC state of the UE device for receiving data from the multicast session comprises: determining that (i) the UE device has not received Point-to-Multipoint (PTM) configuration information the multicast session from the wireless network and (ii) the wireless network has not indicated to the UE device that the PTM configuration information will be provided to the UE device; and selecting a connected RRC state for receiving data from the multicast session.

Example B4 includes the UE device of any of Examples B1-B3. Further, the operations further comprise: receiving, from the base station of the wireless network subsequent to receiving the group paging message, a second group paging message comprising the identifier of the multicast session; inferring, based on the second group paging message, that the activation state of the multicast session of the wireless network has transitioned to a deactivated state; and terminating a receipt of data from the multicast session.

Example B5 includes the UE device of any of Examples B1-B4. Further, the operations further comprise: receiving, from the base station of the wireless network prior to receiving the group paging message, a second group paging message comprising the identifier of the multicast session; inferring, based on the second group paging message, that the activation state of the multicast session of the wireless network has transitioned to a deactivated state; and terminating a receipt of data from the multicast session.

Example B6 includes an apparatus comprising one or more baseband processors configured to perform operations of any of Examples B1-B5.

Example B7 includes a method comprising the operations of any of Examples B1-B5.

Example B8 includes a non-transitory computer storage medium encoded with instructions that, when executed by one or more processors, cause the one or more processors to perform the operations of any of Example B1-B5.

Example C1 includes a UE device comprising one or processors and one or more storage devices on which are stored instructions that are operable, when executed by the one or more processors, to cause the one or more processors to perform operations comprising: receiving, from a base station of a wireless network, Point-to-Multipoint (PTM) configuration information for a multicast session of the wireless network; inferring, based on the PTM configuration information, that an activation state of the multicast session is an activated state; determining that a current Radio Resource Control (RRC) state of the UE device is an inactive RRC state; and receiving data from the multicast session according to the inactive RRC state.

Example C2 includes the UE device of Example C1. Further, the PTM configuration information is received from a Multicast Control Channel (MCCH).

Example C3 includes the UE device of any of Examples C1 and C2. Further, the operations further comprise: receiving a paging message from the base station, the paging message comprising instructions to the UE device to transition to a connected RRC state; and receiving data from the multicast session according to the connected RRC state.

Example C4 includes the UE device of any of Examples C1-C3. Further, the operations further comprise: receiving a paging message from the base station, the paging message indicating a preferred RRC state for the UE device; selecting, based on the paging message, a RRC state of the UE device for receiving data from the multicast session; and receiving data from the multicast session according to the selected RRC state.

Example C5 includes the UE device of any of Examples C1-C4. Further, the preferred RRC state for the UE device is the inactive RRC state, and wherein the selected RRC state is the inactive RRC state.

Example C6 includes the UE device of any of Examples C1-C5. Further, the preferred RRC state for the UE device is the connected RRC state, and wherein the selected RRC state is the connected RRC state.

Example C7 includes an apparatus comprising one or more baseband processors configured to perform operations of any of Examples C1-C6.

Example C8 includes a method comprising the operations of any of Examples C1-C6.

Example C9 includes a non-transitory computer storage medium encoded with instructions that, when executed by one or more processors, cause the one or more processors to perform the operations of any of Example C1-C6.

Example D1 includes a UE device comprising one or processors and one or more storage devices on which are stored instructions that are operable, when executed by the one or more processors, to cause the one or more processors to perform operations comprising: receiving, from a base station of a wireless network, information indicating an activation state of multicast session of the wireless network, wherein the information is included in at least one of: Point-to-Multipoint (PTM) configuration information for the multicast session provided to the UE by the wireless network via a Multicast Control Channel (MCCH), Downlink Control Information (DCI) provided to the UE by the wireless network, or a MCCH notification message; determining, based on the information that an activation state of the multicast session is an activated state; determining that a current Radio Resource Control (RRC) state of the UE device is an inactive RRC state; and receiving data from the multicast session according to the inactive RRC state.

Example D2 includes the UE device of Example D1. Further, the operations further comprise: receiving a paging message from the base station, the paging message comprising instructions to the UE device to transition to a connected RRC state; and receiving data from the multicast session according to the connected RRC state.

Example D3 includes the UE device of any of Examples D1 and D2. Further, the operations further comprise: receiving a paging message from the base station, the paging message indicating a preferred RRC state for the UE device; selecting, based on the paging message, a RRC state of the UE device for receiving data from the multicast session; and receiving data from the multicast session according to the selected RRC state.

Example D4 includes the UE device of any of Examples D1-D3. Further, the preferred RRC state for the UE device is the inactive RRC state, and wherein the selected RRC state is the inactive RRC state.

Example D5 includes the UE device of any of Examples D1-D4. Further, the preferred RRC state for the UE device is the connected RRC state, and wherein the selected RRC state is the connected RRC state.

Example D6 includes an apparatus comprising one or more baseband processors configured to perform operations of any of Examples D1-D5.

Example D7 includes a method comprising the operations of any of Examples D1-D5.

Example D8 includes a non-transitory computer storage medium encoded with instructions that, when executed by one or more processors, cause the one or more processors to perform the operations of any of Example D1-D5.

Example E1 includes a UE device comprising one or processors and one or more storage devices on which are stored instructions that are operable, when executed by the one or more processors, to cause the one or more processors to perform operations comprising: receiving, from a base station of a wireless network, a paging message comprising: first data indicating that an activation state of a multicast session of the wireless network has changed; retrieving, from the wireless network, additional information indicating the activation state of multicast session, wherein the additional information is included in Point-to-Multipoint (PTM) configuration information for the multicast session provided to the UE by the wireless network via a Multicast Control Channel (MCCH); determining, based on the additional information, that the activation state of the multicast session is an activated state; determining that a current Radio Resource Control (RRC) state of the UE device is an inactive RRC state; and receiving data from the multicast session according to the inactive RRC state.

Example E2 includes the UE device of Example E1. Further, the paging message further comprises second data indicating an identifier of the multicast session.

Example E3 includes the UE device of any of Examples E1 and E2. Further, the operations further comprise: receiving a paging message from the base station, the paging message comprising instructions to the UE device to transition to a connected RRC state; and receiving data from the multicast session according to the connected RRC state.

Example E4 includes the UE device of any of Examples E1-E3. Further, the operations further comprise: receiving a paging message from the base station, the paging message indicating a preferred RRC state for the UE device; selecting, based on the paging message, a RRC state of the UE device for receiving data from the multicast session; and receiving data from the multicast session according to the selected RRC state.

Example E5 includes the UE device of any of Examples E1-E4. Further, the preferred RRC state for the UE device is the inactive RRC state, and wherein the selected RRC state is the inactive RRC state.

Example E6 includes the UE device of any of Examples E1-E5. Further, the preferred RRC state for the UE device is the connected RRC state, and wherein the selected RRC state is the connected RRC state.

Example E7 includes an apparatus comprising one or more baseband processors configured to perform operations of any of Examples E1-E6.

Example E8 includes a method comprising the operations of any of Examples E1-E6.

Example E9 includes a non-transitory computer storage medium encoded with instructions that, when executed by one or more processors, cause the one or more processors to perform the operations of any of Example E1-E6.

Example F1 may include a signal as described in or related to any of examples described herein, or portions or parts thereof.

Example F2 may include a datagram, information element, packet, frame, segment, PDU, or message as described in or related to any of examples described herein, or portions or parts thereof.

Example F3 may include a signal encoded with data as described in or related to any of examples described herein, or portions or parts thereof.

Example F4 may include a signal encoded with a datagram, IE, packet, frame, segment, PDU, or message as described in or related to any of examples described herein, or portions or parts thereof.

Example F5 may include an electromagnetic signal carrying computer-readable instructions, wherein execution of the computer-readable instructions by one or more processors is to cause the one or more processors to perform the method, techniques, or process as described in or related to any of examples described herein, or portions thereof.

Example F6 may include a computer program including instructions, wherein execution of the program by a processing element is to cause the processing element to carry out the method, techniques, or process as described in or related to any of examples described herein, or portions thereof.

Example F7 may include a signal in a wireless network as shown and described herein.

Example F8 may include a method of communicating in a wireless network as shown and described herein.

Example F9 may include a system for providing wireless communication as shown and described herein. The operations or actions performed by the system can include the methods of any one of examples described herein.

Example F10 may include a device for providing wireless communication as shown and described herein. The operations or actions performed by the device can include the methods of any one of examples described herein.

The previously-described examples are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any of examples described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-43. (canceled)

44. A method comprising:
receiving, from a base station in a wireless network, a group paging message comprising:
first data indicating an activation state of a multicast session of the wireless network, and
second data indicating an identifier of the multicast session;
determining that a current Radio Resource Control (RRC) state of a user equipment (UE) device is an inactive RRC state;
selecting, based on the group paging message and the current RRC state of the UE device, a RRC state of the UE device for receiving data from the multicast session; and
receiving data from the multicast session according to the selected RRC state.

45. The method of claim 44, wherein the group paging message further comprises third data indicating a preferred RRC state for the UE device selected by the wireless network, and
wherein selecting the RRC state of the UE device for receiving data from the multicast session comprises:
determining that the activation state of the multicast session is an activated state,
determining that the preferred RRC state is an inactive RRC state, and
selecting the inactive RRC state for receiving data from the multicast session.

46. The method of claim 44, wherein the group paging message further comprises third data indicating a preferred RRC state for the UE device selected by the wireless network, and
wherein selecting the RRC state of the UE device for receiving data from the multicast session comprises:
determining that the activation state of the multicast session is an activated state,
determining that the preferred RRC state is a connected RRC state, and
selecting the connected RRC state for receiving data from the multicast session.

47. The method of claim 44, wherein selecting the RRC state of the UE device for receiving data from the multicast session comprises:
determining that the activation state of the multicast session is an activated state,
determining an absence of data indicating a preferred RRC state for the UE device in the group paging message,
determining that at least one of (i) the UE device has received Point-to-Multipoint (PTM) configuration information for the multicast session from the wireless network or (ii) the wireless network has indicated to the UE device that the PTM configuration information will be provided to the UE device, and
selecting the inactive RRC state for receiving data from the multicast session.

48. The method of claim 44, wherein selecting the RRC state of the UE device for receiving data from the multicast session comprises:
determining that the activation state of the multicast session is an activated state,
determining an absence of data indicating a preferred RRC state for the UE device in the group paging message,
determining that (i) the UE device has not received Point-to-Multipoint (PTM) configuration information for the multicast session from the wireless network and (ii) the wireless network has not indicated to the UE that the PTM configuration information will be provided to the UE device, and
selecting a connected RRC state for receiving data from the multicast session.

49. The method of claim 44, further comprising:
receiving, from the base station of the wireless network, a second group paging message indicating that the activation state of the multicast session of the wireless network is a deactivated state, and
terminating a receipt of data from the multicast session.

50. An apparatus comprising:
one or more processors; and
memory storing instructions that, when executed, cause the one or more processors to perform operations comprising:
receiving, from a base station in a wireless network, a group paging message comprising:
first data indicating an activation state of a multicast session of the wireless network, and
second data indicating an identifier of the multicast session;
determining that a current Radio Resource Control (RRC) state of a user equipment (UE) device is an inactive RRC state,
selecting, based on the group paging message and the current RRC state of the UE device, a RRC state of the UE device for receiving data from the multicast session; and
receiving data from the multicast session according to the selected RRC state.

51. The system of claim 50, wherein the group paging message further comprises third data indicating a preferred RRC state for the UE device selected by the wireless network, and
wherein selecting the RRC state of the UE device for receiving data from the multicast session comprises:
determining that the activation state of the multicast session is an activated state,
determining that the preferred RRC state is an inactive RRC state, and
selecting the inactive RRC state for receiving data from the multicast session.

52. The system of claim 50, wherein the group paging message further comprises third data indicating a preferred RRC state for the UE device selected by the wireless network, and
wherein selecting the RRC state of the UE device for receiving data from the multicast session comprises:
determining that the activation state of the multicast session is an activated state,
determining that the preferred RRC state is a connected RRC state, and
selecting the connected RRC state for receiving data from the multicast session.

53. The system of claim 50, wherein selecting the RRC state of the UE device for receiving data from the multicast session comprises:
determining that the activation state of the multicast session is an activated state,
determining an absence of data indicating a preferred RRC state for the UE device in the group paging message,
determining that at least one of (i) the UE device has received Point-to-Multipoint (PTM) configuration information for the multicast session from the wireless network or (ii) the wireless network has indicated to the UE device that the PTM configuration information will be provided to the UE device, and
selecting the inactive RRC state for receiving data from the multicast session.

54. The system of claim 50, wherein selecting the RRC state of the UE device for receiving data from the multicast session comprises:
determining that the activation state of the multicast session is an activated state,
determining an absence of data indicating a preferred RRC state for the UE device in the group paging message,
determining that (i) the UE device has not received Point-to-Multipoint (PTM) configuration information for the multicast session from the wireless network and (ii) the wireless network has not indicated to the UE that the PTM configuration information will be provided to the UE device, and
selecting a connected RRC state for receiving data from the multicast session.

55. The system of claim 50, the operations further comprising:
receiving, from the base station of the wireless network, a second group paging message indicating that the activation state of the multicast session of the wireless network is a deactivated state, and
terminating a receipt of data from the multicast session.

56. A method comprising:
transmitting, to a user equipment (UE) device of in a wireless network, a group paging message comprising:
first data indicating an activation state of a multicast session of the wireless network, and
second data indicating an identifier of the multicast session;
causing the UE device to receive data in the multicast session according to a selected Radio Resource Control (RRC) state, wherein causing the UE device to receive data in the multicast session according to the selected RRC state comprises causing the UE to perform operations comprising:
determining that a current RRC state of the UE device is an inactive RRC state, and
determining the selected RRC state based on the group paging message and the current RRC state of the UE device.

57. The method of claim 56, wherein the group paging message further comprises third data indicating a preferred RRC state for the UE device selected by the wireless network, and
wherein the operations further comprise:
determining that the activation state of the multicast session is an activated state,
determining that the preferred RRC state is an inactive RRC state, and
selecting the inactive RRC state as the selected RRC state.

58. The method of claim 56, wherein the group paging message further comprises third data indicating a preferred RRC state for the UE device selected by the wireless network, and
wherein the operations further comprise:
determining that the activation state of the multicast session is an activated state,
determining that the preferred RRC state is a connected RRC state, and
selecting the connected RRC state as the selected RRC state.

59. The method of claim 56, wherein the operations further comprise:
determining that the activation state of the multicast session is an activated state,
determining an absence of data indicating a preferred RRC state for the UE device in the group paging message,
determining that at least one of (i) the UE device has received Point-to-Multipoint (PTM) configuration information for the multicast session from the wireless network or (ii) the wireless network has indicated to the UE device that the PTM configuration information will be provided to the UE device, and
selecting the inactive RRC state as the selected RRC state.

60. The method of claim 56, wherein selecting the RRC state comprises:
determining that the activation state of the multicast session is an activated state,
determining an absence of data indicating a preferred RRC state for the UE device in the group paging message,
determining that (i) the UE device has not received Point-to-Multipoint (PTM) configuration information for the multicast session from the wireless network and (ii) the wireless network has not indicated to the UE that the PTM configuration information will be provided to the UE device, and
selecting a connected RRC state as the selected RRC state.

61. The method of claim 56, further comprising:
transmitting, to the UE device, a second group paging message indicating that the activation state of the multicast session of the wireless network is a deactivated state, and
terminating a transmission of data using the multicast session.
